(19) United States
(12) Patent Application Publication
(10) Pub. No.: US 2004/0142061 A1
(43) Pub. Date: Jul. 22, 2004

(54) Apparatus for forming pottery

(76) Inventor: Kenton T. Oakes, El Cajon, CA (US)

Correspondence Address: Gary M. Nath, NATH & ASSOCIATES PLLC, 6th Floor, 1030 15th Street, N.W., Washington, DC, 20005, US

(21) Appl. No.: 10/749,389

(22) Filed: Jan. 2, 2004

Related U.S. Application Data
(63) Continuation-in-part of application No. 10/146,143, filed on May 16, 2002, now abandoned.
(63) Continuation-in-part of application No. 10/147,223, filed on May 17, 2002, now abandoned.
(63) Continuation-in-part of application No. 29/179,458, filed on Apr. 11, 2003.

(51) Int. Cl. B28B 1/02

(52) U.S. Cl. 425/263; 425/459

(57) ABSTRACT

A portable, table-top apparatus for throwing a pot has an exoskeletal housing having a first recess in an underside thereof. A pottery wheel having a diameter of from about two to fifteen inches and having a wheel-head height of less than about 6 inches above the table-top has an upwardly facing flat surface adapted to support a clay mass of up to about 50 pounds. The pottery wheel is supported by the housing to be rotatable about a vertical axis. A reversible motor of greater than about ⅛ horsepower is disposed in the first recess and coupled to the wheel to rotate the wheel about the axis at an adjustable rotational speed from 0 to about 350 rpm in each of the clockwise and counterclockwise directions. A further recess in a top side of the exoskeletal housing is adapted to hold a bucket, such as a water bucket or a tool bucket.

### RELATED APPLICATIONS

This application is a continuation-in-part of U.S. patent application Ser. No. 10/146,143 filed May 16, 2002; and a continuation-in-part of U.S. patent application Ser. No. 10/147,223 filed May 17, 2002; and a continuation-in-part of U.S. patent application Ser. No. 29/179,458 filed Apr. 11, 2003; the contents of each of which are incorporated herein by reference in their entirety.

### FIELD OF THE INVENTION

This invention relates generally to pottery wheels, and, more particularly, to portable table-top pottery wheel apparatus.

### BACKGROUND OF THE INVENTION

Pottery wheels for manually throwing pottery typically are used for forming pottery, such as bowls, pots, vases, and the like. Such conventional pottery wheels are usually more than a foot in diameter, and can support and center as much as 100 to 200 pounds of clay or other working material. In order to overcome the inertia of a 100-200 pound mass of clay, prior art pottery wheel driving means are typically relatively large electric motors. Such pottery wheel apparatus are usually integrally built into a floor mounted table or bench due to the significant combined weight of the electric motor, pottery wheel, and clay mass or other working material supported thereby. Consequently, most pottery wheel apparatus are not easily portable. Further, most prior art pottery wheel apparatus are not well suited to be casually carried about from place to place.

Several prior art patents, however, do teach pottery wheel apparatus that are portable. For example, U.S. Pat. No. 4,028,041 to Zambrano, Jr., incorporated herein by reference, discloses a potter's wheel that is compact and relatively light-weight. The Zambrano, Jr. potter's wheel has a casing and a turntable assembly mounted on the casing. The turntable assembly includes a turntable having a peripheral rim and a bearing assembly. The turntable is rotatably mounted on the casing and is rotatably coupled to the bearing assembly. A motor having a shaft is mounted below the turntable within a motor housing such that the shaft projects outwardly from the housing and is rollably engagable with an inside edge of the turntable rim. A leaf spring secured to the motor housing contacts a wall of the casing to urge the housing to a first position in which the motor shaft contacts the turntable rim. In this position, the turntable is driven by the motor. A cam member mounted on the motor housing slideably engages the casing wall to urge the housing to a second position in which the motor shaft is spaced apart from the turntable rim. In this position, the turntable may be manually rotated as a lazy susan.

In order to accommodate the height of the motor mounted within the housing, such a device requires significant clearance relative to the top of a support surface, such as a counter or table. This clearance requirement results in an upper or working surface of the turntable being positioned in an ergonomically unsatisfactory position which can cause fatigue, stress, and possible bodily injury to a user.

Similarly, U.S. Pat. No. 5,230,909 to Stanly, incorporated herein by reference, discloses a battery operated potter's wheel for forming miniature doll house pottery. The Stanly potter's wheel has a wheel diameter no larger than two inches and operates at extremely high rotational velocities, such as up to 10,000 revolutions per minute (rpm). Due to the miniature size of the wheel, a user can rest his hands on a support base while performing the delicate forming operations necessary for throwing miniature pottery. However, due to the miniature size, conventional pottery which requires a large clay mass can not be centered and rotated by the Stanly wheel. Moreover, large clay masses can not be safely rotated at the high rotational speeds at which the Stanly device operates.

Clearly, then, there is a need for an ergonomically designed pottery wheel apparatus that is portable, light-weight, and capable of safely centering the large clay mass needed to form conventional pottery without subjecting the user to risk of fatigue, stress, and bodily injury; and that is simple to manufacture and easy to clean and maintain. The present invention fulfills these needs and provides further related advantages.

### SUMMARY OF THE INVENTION

The present invention relates to a professional level apparatus for forming pottery that is portable, can be easily transported, and is adapted to be used on any convenient support surface while simultaneously having a low profile that provides an ergonomically desirable working height relative to that support surface.

In a preferred embodiment, the apparatus is adapted to be used on a table top with a wheel-head height of less than or equal to about 6 inches, and preferably less than about 4 inches, above the table top. Alternatively, legs can be attached to the apparatus to elevate the apparatus above a support surface such as a floor.

The apparatus comprises a base and a molded shell or housing that forms an exoskeleton. The exoskeleton is preferably made from an injection molded plastic. Such plastics can include ABS and PVC or other conventionally known moldable, rigid plastics. Other materials that do not rust, are impervious to water, and are easily cleaned can also be used. A plurality of rubber or elastomeric feet are mounted to a bottom side of the base to prevent the apparatus from walking off the support table due to any vibration during use. In a preferred embodiment about 8 to 12 feet of about 1 inch diameter each are arranged on the base. In an alternative embodiment the base can be rigidly mounted to the support table.

The exoskeleton is preferably shaped in the form of a compound curve that accommodates ready access to a wheel head about an arc subtending about 300 degrees around the circumference of the wheel head. A pocket or bucket holder is molded into an upper side of the exoskeleton and is adapted to hold accessories such as a bucket of water or bucket of tools in a fixed location that is conveniently reached by a user while the apparatus is in use. In the currently preferred embodiment two bucket holders are molded into the exoskeletal housing. For symmetry of design and convenience for both right and left handed users, in the presently preferred embodiment the bucket holders are arranged laterally on opposite sides of an upper side hump corresponding to an under side motor enclosure recess that accommodates a motor, and are arranged between a vertical axis of the wheel and a vertical axis of the motor. Other numbers of bucket holders and relative arrangements of the bucket holders are also feasible. In a further preferred embodiment a tool holder can be attached to a top surface of the upper side hump. A splash pan surrounds the wheel head and is connected to the exoskeleton to catch water and particulates that are thrown by centrifugal force during rotation of a clay mass or other manipulation of the clay mass.

A pottery wheel comprises a wheel head which has a diameter of from two to fifteen inches. The pottery wheel is supported on the housing for rotational motion about a vertical axis. The wheel head floats on a thrust washer and/or bearing to prevent vertical run-out. The wheel head is adapted to accept a mass of up to about 50 pounds of clay. In a currently preferred embodiment the wheel head is adapted to accept a mass of up to about 30 pounds of clay. The wheel head has an upwardly facing flat surface for supporting the mass of clay to be formed into the pottery. In a preferred embodiment the wheel head and a support/drive shaft are rigidly and integrally coupled into a unitized assembly.

A reversible drive means is coupled to the pottery wheel for rotating the wheel about the vertical axis at an adjustable rotational speed ranging from 0 to about 350 r.p.m. in either a clockwise or counterclockwise direction, and more preferably from 0 to about 220 r.p.m. Preferably the drive means comprises an electric motor of not less than ⅛ horsepower, and more preferably of about ⅓ horsepower, that is mounted in the motor enclosure recess in the underside of the exoskeleton. In a currently preferred embodiment the motor is oriented with its output shaft pointed in a downward direction while at the same time being above the plane of the base. In an alternate embodiment the motor can be mounted horizontally with its output shaft vertically aligned between the plane of the base and an underside of the wheel head. In yet a further alternate embodiment a pancake type motor can be used. In the currently preferred embodiment the motor is operatively coupled to the wheel head by a belt, gear or chain drive to provide rotational motion. In an alternate embodiment the motor can be directly coupled to the wheel head. A clutch mechanism can also be operatively connected between the motor and the wheel head. In yet a further embodiment one of an armature and a stator of the motor can be built into the wheel head with the other of the armature and the stator of the motor built into the exoskeleton.

The apparatus is preferably small and light weight enough so that it may be supported by a hand and easily carried.

A switch is preferentially included that breaks an electrical circuit between the drive means and a power source, thereby allowing inertial braking of the wheel by the motor to slow the rotation of the wheel. Alternatively a frictional brake can be provided. In yet a further embodiment the clutch mechanism, if provided, can be activated/de-activated by the switch so that inertial braking is by the wheel head alone. The switch may then be reconnected to restore motive force to the wheel head and thereby resume the wheel's rotational speed. In a preferred embodiment the switch is integrally combined with a circuit breaker. The switch can also be conventionally connected in series with a separate circuit breaker.

In the presently preferred embodiment the motor rotational speed is regulated by a hand control that regulates and adjusts an internal motor speed control circuitry. Alternatively a foot control, a knee control, or another control, or combinations thereof, can be connected to a jack connection on the exoskeletal housing to regulate and adjust the internal motor speed control circuitry. In a currently preferred embodiment the internal motor speed control circuitry comprises a microprocessor speed controller that controls the rotational speed of the motor based on a setting input by the user through the hand or foot control. A sensor can also be connected to the microprocessor to detect changes in wheel head rotational speed caused by mechanical load variations and/or electrical current variations so that the microprocessor can compensate and adjust the rotational speed of the motor so as to maintain constant the desired r.p.m. of the wheel head.

A vibrational means can be included that produces lateral vibrational excursions of the wheel head. The vibration means allows special effects to be molded into the pottery by producing lateral movements while the pottery is rotated by the wheel head.

The apparatus of the present invention is extremely portable and light-weight and easily fits in a back-pack, custom carry case, or the like. As such, the present invention allows the user to easily transport the potters wheel apparatus so as to take advantage of the relaxing effects of forming pottery almost anywhere. Further, the present invention is extremely easy to manufacture, clean, and maintain, due to its relatively small size and uncomplicated design. These and other objects, features, and advantages of the invention will be better understood by those skilled in the art by reference to the following detailed description taken together with the following drawings in which like numerals identify like components throughout the several views.

### BRIEF DESCRIPTION OF THE DRAWINGS

FIG. 1 is a perspective view of the table top potter's wheel of the present invention;

FIG. 2 is a top view of the table top potter's wheel of FIG. 1;

FIG. 3 is a left side view of the table top potter's wheel of FIG. 1;

FIG. 4 is a cross sectional view of the table top potter's wheel, taken generally along lines 4--4 of FIG. 2, illustrating a power source and a rotational drive means of the invention;

FIG. 5 is a cross sectional view of the table top potter's wheel, taken generally along lines 5--5 of FIG. 2, illustrating a motor mounted in a motor mount recess; and

FIG. 6. is a perspective view of an electronics module of the table top potter's wheel of FIG. 1.

### DETAILED DESCRIPTION OF THE INVENTION

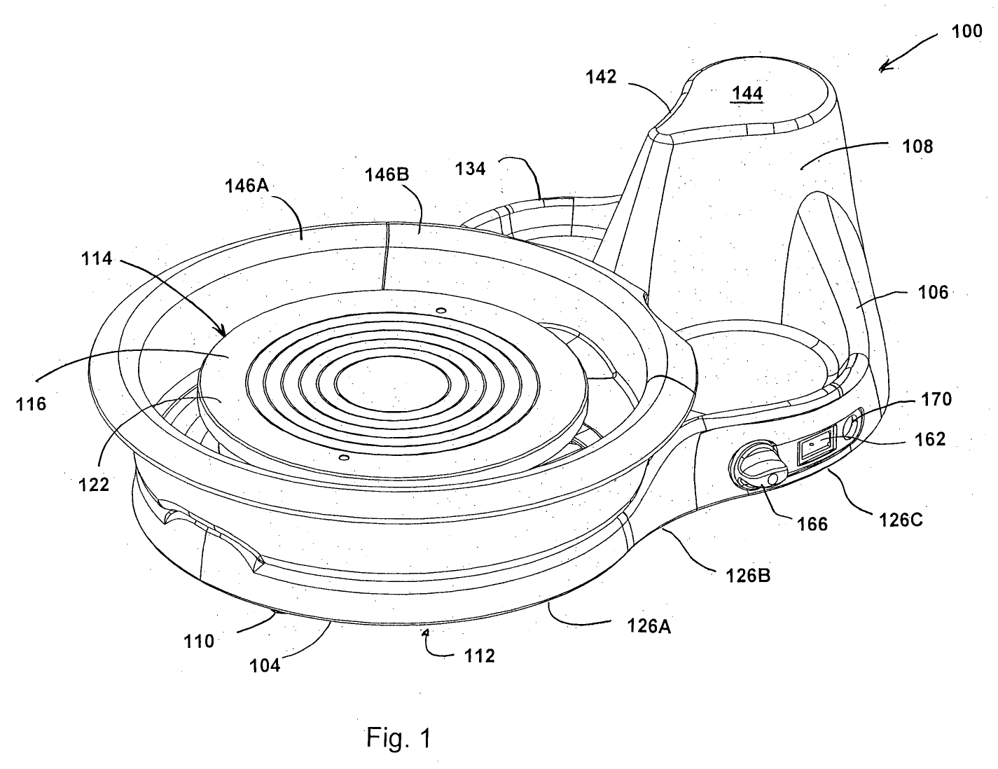

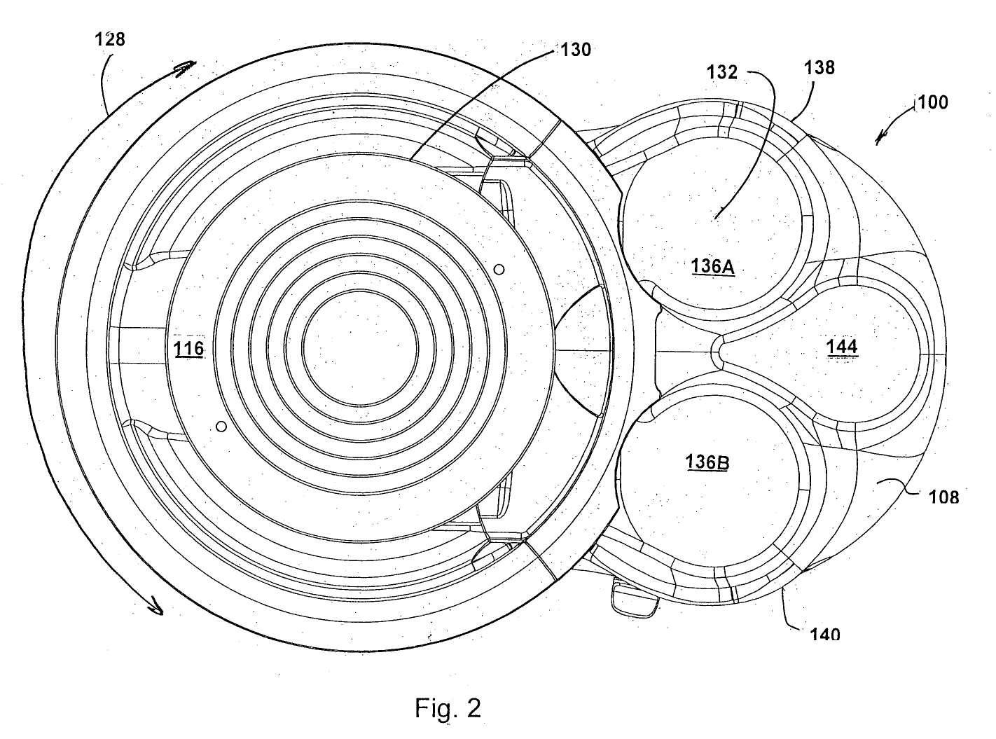

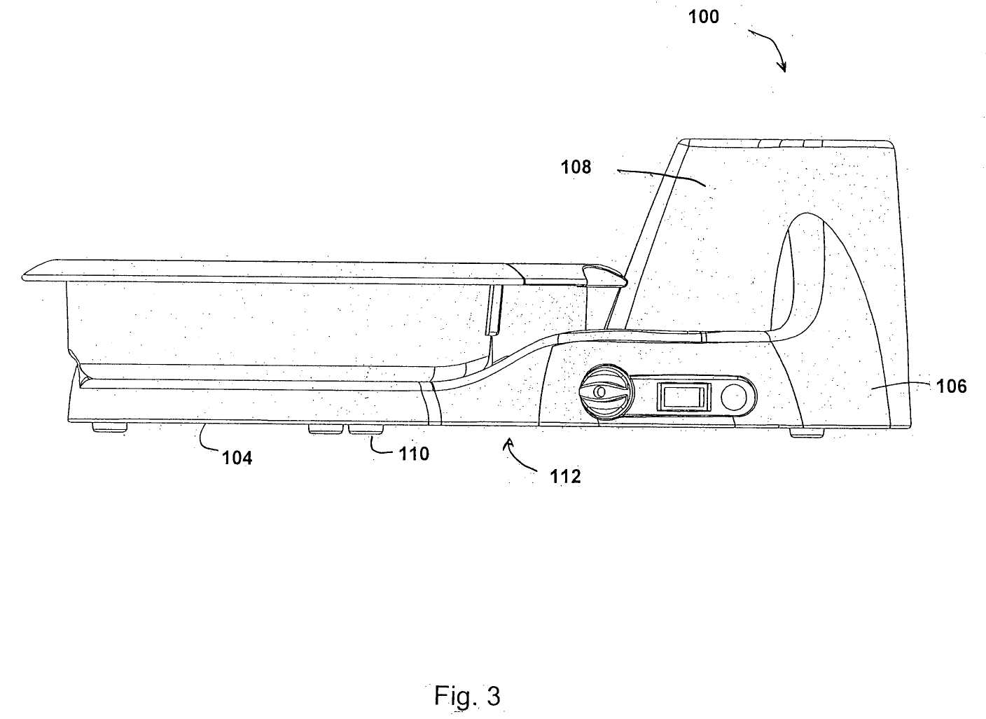

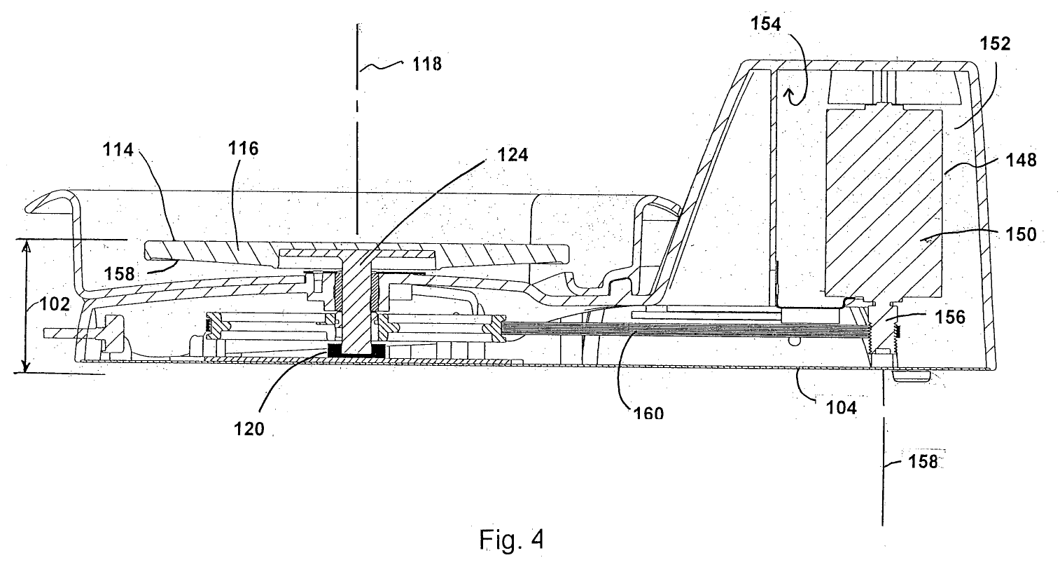

Referring now to FIGS. 1-3, there is shown a table top potter's wheel 100. Potter's wheel 100 is adapted to be used on a table top (not shown) and has a wheel-head height 102, as shown in FIG. 4, of less than or equal to about 6 inches, and preferably less than about 4 inches above the table top or other support surface (not shown). Alternatively, legs (not shown) can be attached to table top potter's wheel 100 to elevate table top potter's wheel 100 above the support surface such as a floor (not shown).

Table top potter's wheel 100 comprises a base 104 and a molded shell or housing 106 that forms an exoskeleton 108. Exoskeleton 108 is preferably made from an injection molded plastic. Such plastics can include ABS and PVC or other conventionally known moldable, rigid plastics. Other materials that do not rust, are impervious to water, and are easily cleaned can also be used. A plurality of rubber or elastomeric feet 110 are mounted to bottom side 112 of base 104.

A pottery wheel 114 comprises a wheel head 116 which has a diameter of from two to fifteen inches. Pottery wheel 114 is supported on housing 106 for rotational motion about a vertical axis 118 as shown in FIG. 4. Pottery wheel 114 floats on a thrust washer and/or bearing 120, also shown in FIG. 4, to prevent vertical run-out. Wheel head 116 is adapted to accept a mass of up to about 50 pounds of clay (not shown). Wheel head 116 has an upwardly facing flat surface 122 for supporting the mass of clay (not shown) to be formed into the pottery (not shown). In a preferred embodiment wheel head 116 and support/drive shaft 124 (shown in FIG. 4) are rigidly and integrally coupled into a unitized assembly.

The size of the wheel head 116 is a critical component of the presently claimed apparatus. In particular, if wheel head 116 is larger than about fifteen inches in diameter, it requires as a driving means a large, heavy electric motor. Accordingly, such an apparatus is not easily portable. The present portable table top potter's wheel 100, having a wheel head 116 with a diameter which cannot be greater than fifteen inches, avoids these problems. Instead, since the diameter of the wheel head 116 of the present portable table top potter's wheel 100 cannot be greater than fifteen inches, the portable table top potter's wheel 100 can be both deployed on a desktop (not shown) or tabletop (not shown) and is easily portable and storable.

Exoskeleton 108 is preferably shaped in the form of a compound curve 126a, 126b, 126c that accommodates ready access to wheel head 116 about an arc 128 that subtends about 300 degrees around the circumference 130 of wheel head 116. A pocket or bucket holder 132 is molded into an upper side 134 of exoskeleton 108 and is adapted to hold accessories such as a bucket of water (not shown) or bucket of tools (not shown) in a fixed location that is conveniently reached by a user while the apparatus is in use. In the currently preferred embodiment two bucket holders 136a, 136b are molded into exoskeletal housing 108. Bucket holders 136a, 136b are arranged laterally on opposite sides 138, 140 of an upper side hump 142. A tool holder (not shown) can be attached to a top surface 144 of upper side hump 142. A two-part splash pan 146a, 146b surrounds wheel head 116 and is connected to exoskeleton 108.

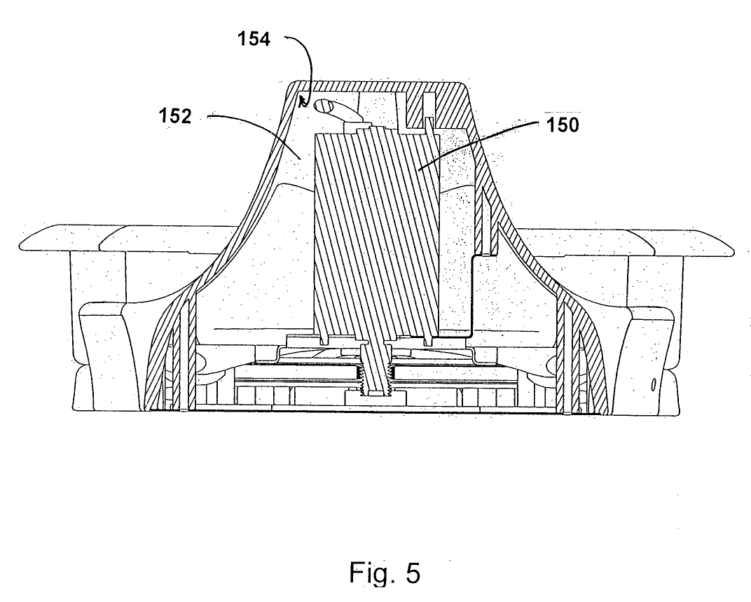

Referring now to FIGS. 4-5, a reversible drive means 148 is coupled to pottery wheel 114 for rotating wheel head 116 about vertical axis 118 at an adjustable rotational speed ranging from 0 to about 350 r.p.m. in either a clockwise or counterclockwise direction, and more preferably from 0 to about 220 r.p.m. Such rotational speeds provide sufficient rotational momentum to pottery wheel 114 such that vigorous forming of pottery may be achieved without significant slowing of wheel head 116. As such, pottery wheel 114, while being relatively small, demonstrates enough rotational momentum that additional fly wheel devices are not necessary.

Preferably drive means 148 comprises an electric motor 150 of not less than ⅛ horsepower, and more preferably of about ⅓ horsepower, that is mounted in motor enclosure recess 152 in underside 154 of exoskeleton 108. Motor enclosure recess 152 corresponds to an underside of hump 142 in exoskeletal housing 108. In a currently preferred embodiment motor 150 is oriented with its output shaft 156 pointed in a downward direction along a vertical axis 158 parallel to vertical axis 118 of pottery wheel 114 and is at the same time above the plane of the base 104. Vertical axis 158 is preferably on a side of bucket holders 136a, 136b in exoskeletal housing 108 opposite vertical axis 118 of pottery wheel 114.

In an alternate embodiment (not shown) the motor can be mounted horizontally with its output shaft vertically aligned between the plane of base 104 and an underside 158 of wheel head 116. Motor 150 is operatively coupled to wheel head 116 by belt 160 to provide rotational motion.

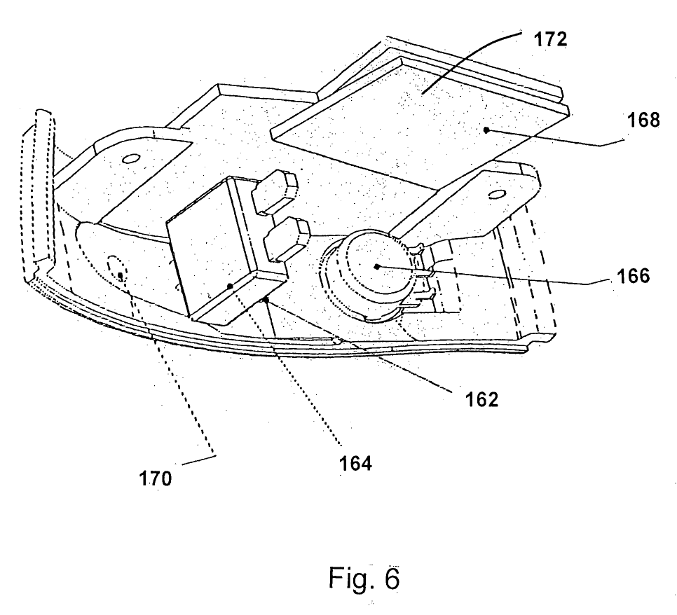

Referring back to FIGS. 1-3, and to FIG. 6, a switch 162 breaks an electrical circuit (not shown) between drive means 148 and a power source (not shown). In a preferred embodiment switch 162 is integrally combined with a circuit breaker, such as circuit breaker 164 shown in FIG. 6.

Rotational speed of motor 150 and therefore of wheel head 116 is regulated by hand control 166 that regulates and adjusts internal motor speed control circuitry 168. Alternatively a foot control (not shown), a knee control (not shown), or another control (not shown), or combinations thereof, can be connected to internal motor speed control circuitry 168 through a jack 170. Internal motor speed control circuitry 168 comprises a microprocessor speed controller 172 that controls the rotational speed of motor 150 based on an input setting established by the user through the hand or foot control, such as hand control 166. A sensor (not shown) can also be connected to microprocessor speed controller 172 to detect changes in rotational speed of wheel head 116 caused by mechanical load variations and/or electrical current variations so that microprocessor speed controller 172 can compensate and adjust the rotational speed of motor 150 to maintain the desired r.p.m. of wheel head 116.

While the invention has been described with reference to a currently preferred embodiment, it is to be clearly understood by those skilled in the art that the invention is not limited thereto. Rather, the scope of the invention is to be interpreted only in conjunction with the appended claims.

I claim:

1. A portable, table-top apparatus for throwing a pot comprising:
a base;
a shell or housing carried on said base;
a pottery wheel carried by said shell and adapted for rotational motion about a vertical axis, said pottery wheel comprising a wheel-head having an upwardly facing flat surface adapted to accept a mass of up to about 50 pounds of clay;
a plurality of rubber or elastomeric feet mounted to a bottom side of said base, a vertical displacement of said upwardly facing flat surface relative to bottoms of said plurality of feet being about 4 to 6 inches;
a drive-motor operatively coupled to said wheel-head to provide said rotational motion, said drive-motor being disposed, at least in part, above a plane of said upwardly facing flat surface; and
speed control circuitry connected to said drive-motor to control a rotational speed thereof.

2. The portable, table-top apparatus as claimed in claim 1, wherein to prevent vertical run-out said pottery wheel floats on one of a thrust washer and a thrust bearing.

3. The portable, table-top apparatus as claimed in claim 1, said pottery wheel further comprising a unitized assembly comprising a support/drive shaft that is rigidly and integrally coupled to said wheel-head.

4. The portable table-top apparatus as claimed in claim 1, wherein said drive-motor is reversible.

5. The portable table-top apparatus as claimed in claim 4, wherein a speed of said drive-motor is adjustable from 0 to about 350 r.p.m. in each of a clockwise and a counterclockwise direction.

6. The portable table-top apparatus as claimed in claim 1, ⅓ horsepower.

7. The portable table-top apparatus as claimed in claim 1, said drive-motor being mounted in a motor enclosure recess in an underside of said shell.

8. The portable table-top apparatus as claimed 1, said drive-motor having an output shaft oriented in a downward direction and aligned parallel to the vertical axis of said pottery wheel.

9. The portable table-top apparatus as claimed in claim 1, further comprising an electrical power supply circuit having a switch interposed therein connected to said drive-motor.

10. The portable table-top apparatus as claimed in claim 9, said power supply circuit further comprising a circuit breaker.

11. The portable table-top apparatus as claimed in claim 10, wherein said switch and said circuit breaker are integrally combined.

12. The portable table-top apparatus as claimed in claim 1, said speed control circuitry comprising a microprocessor.

13. The portable table-top apparatus as claimed in claim 1, further comprising a control connected to said speed control circuitry to regulate and adjust said speed control circuitry.

14. The portable table-top apparatus as claimed in claim 1, further comprising a control jack connected to said speed control circuitry.

15. The portable table-top apparatus as claimed in claim 14, further comprising an external control connected to said control jack.

16. A portable, table-top apparatus for throwing a pot comprising:
a base;
an exoskeleton carried on said base;
a pottery wheel carried by said exoskeleton and adapted for rotational motion about a vertical axis, said pottery wheel comprising a wheel-head having an upwardly facing flat surface;
a drive-motor operatively coupled to said wheel-head to provide said rotational motion;
speed control circuitry connected to said drive-motor to control a rotational speed thereof; and
wherein said exoskeleton further comprises:
a pocket or bucket-holder in an upper side thereof, said bucket-holder being adapted to hold accessories in a fixed location relative to said pottery wheel, and
a splash pan that surrounds said wheel-head.

17. A portable, table-top apparatus for throwing a pot comprising:
a base;
an exoskeleton carried on said base;
a pottery wheel carried by said exoskeleton and adapted for rotational motion about a vertical axis, said pottery wheel comprising a wheel-head having an upwardly facing flat surface;
wherein said exoskeleton comprises a compound curve that subtends an arc of about 300 degrees around a circumference of said wheel-head.

18. The portable, table-top apparatus as claimed in claim 17, said exoskeleton comprising an injection molded plastic.

19. The portable, table-top apparatus as claimed in claim 17, said exoskeleton further comprising an upper-side hump having an upper surface adapted to accept a tool holder attached thereto, said hump comprising a cover over a drive-motor space.

20. The portable, table-top apparatus as claimed in claim 17, said exoskeleton further comprising a pocket or bucket-holder in an upper side thereof, said bucket-holder being adapted to hold accessories in a fixed location relative to said pottery wheel.

21. The portable, table-top apparatus as claimed in claim 20, further comprising a plurality of bucket-holders in said exoskeleton.

22. The portable table-top apparatus as claimed in claim 21, wherein ones of said plurality of bucket-holders are arranged laterally on opposite sides of a longitudinal axis of said exoskeleton.

23. The portable table-top apparatus as claimed in claim 17, said exoskeleton further comprising:
an upper-side hump comprising a cover over a drive-motor space; and
a bucket-holder in an upper side thereof;
wherein said bucket-holder is disposed longitudinally between the vertical axis of said pottery wheel and said upper-side hump.

24. The portable table-top apparatus as claimed in claim 17, further comprising a splash pan that surrounds said wheel-head connected to said exoskeleton.
